(19) United States
(12) Patent Application Publication
(10) Pub. No.: US 2024/0347049 A1
(43) Pub. Date: Oct. 17, 2024

(54) ELECTRONIC DEVICE THAT PERFORMS A NEURAL NETWORK BASED FAQ CLASSIFICATION AND A NEURAL NETWORK TRAINING

(71) Applicant: 42dot Inc., Seoul (KR)

(72) Inventors: Cheoneum Park, Seongnam-si (KR); Byeongyeol Kim, Seoul (KR); Juae Kim, Seoul (KR); Seohyoeng Jeong, Suwon-si (KR)

(21) Appl. No.: 18/630,399

(22) Filed: Apr. 9, 2024

(30) Foreign Application Priority Data
Apr. 11, 2023 (KR) 10-2023-0047672

(51) Int. Cl. G10L 15/16; G10L 15/02; G10L 15/06; G10L 15/183

(52) U.S. Cl. CPC G10L 15/16; G10L 15/02; G10L 15/063; G10L 15/183

(57) ABSTRACT

An electronic device includes a memory configured to store instructions and a processor electrically connected to the memory and configured to execute the instructions, in which when the instructions are executed by the processor, the processor is configured to perform a plurality of operations, in which the plurality of operations includes deriving a frequently-asked-questions (FAQ) pair from speech data based on a neural network model trained in an end-to-end manner, in which the neural network model is based on a multi-modal language model (LM) capable of using text data and speech data simultaneously, and contrastive learning is performed on the neural network model based on symmetric loss to shift speech data, which is original data, to text data, which is augmented data

### 1. FIELD OF THE INVENTION

One or more embodiments relate to an electronic device for performing neural network-based frequently-asked-questions (FAQ) classification and neural network training.

### 2. DESCRIPTION OF THE RELATED ART

A frequently-asked-questions (FAQ) system is a system that provides a pre-stored answer to an FAQ. The purpose of the FAQ system is to enable a user to quickly and easily find information they desire without having to contact a customer service representative or search for a long document.

The FAQ system is frequently used by businesses and organizations to solve general customer inquiries, technical issues, or policy-related questions. The FAQ system may be implemented through a website, a mobile app, or other digital platforms.

As the need for a service that provides an answer to a question of a user related to vehicle control increases, research and development are required to improve the accuracy and quality of the service. Since there are spatial and situational restrictions on the movement of a user in a vehicle, an FAQ system that identifies the intention through the utterance of a user and provides a service the user desires may be useful.

### SUMMARY

According to an aspect, there is provided an electronic device including a memory configured to store instructions and a processor electrically connected to the memory and configured to execute the instructions, in which, when the instructions are executed by the processor, the processor is configured to perform a plurality of operations, in which the plurality of operations includes deriving a frequently-asked-questions (FAQ) pair from speech data based on a neural network model trained in an end-to-end manner, and in which the neural network model is based on a multi-modal language model (LM) capable of using text data and speech data simultaneously, and contrastive learning is performed on the neural network model based on symmetric loss to shift speech data, which is original data, to text data, which is augmented data.

Multi-task learning, which uses the symmetric loss and cross-entropy loss simultaneously, may be performed on the neural network model.

The symmetric loss may be calculated based on a cosine similarity between probability vectors that are intermediate outputs of the neural network model for each of speech data and text data, and the cross-entropy loss may be calculated based on the FAQ pair that is a final output of the neural network model.

The neural network model may include a shared encoder configured to output a first latent vector based on preprocessed speech data, a bidirectional recurrent neural network layer configured to output a second latent vector based on the first latent vector, a predictor configured to output a probability vector indicating a correlation between speech data and all FAQ pairs based on the second latent vector, a feed-forward neural network (FFNN) layer configured to output an activation value based on the probability vector, and a classifier configured to output a final FAQ pair based on the activation value.

The deriving of the FAQ pair may include extracting a feature vector of received speech data, obtaining preprocessed speech data by performing speech encoding on the feature vector, and inputting the preprocessed speech data to the neural network model.

The shared encoder may have at least one of text data or speech data as an input, based on the multi-modal LM.

The bidirectional recurrent neural network layer may consider a sequential characteristic of text data or speech data.

The neural network model may have one of preprocessed speech data or non-preprocessed speech data as an input.

According to another aspect, there is provided an electronic device including a memory configured to store instructions and a processor electrically connected to the memory and configured to execute the instructions, in which, when the instructions are executed by the processor, the processor is configured to perform a plurality of operations, and in which the plurality of operations includes deriving one FAQ pair from speech data and text data based on a neural network model, calculating symmetric loss based on probability vectors that are intermediate outputs of the neural network model for each of the speech data and the text data, calculating cross-entropy loss based on the one FAQ pair that is a final output of the neural network model for the speech data, and performing multi-task learning, which uses the symmetric loss and the cross-entropy loss simultaneously, on the neural network model.

The neural network model may be trained in an end-to-end manner.

Training of the neural network model may include contrastive learning based on the symmetric loss to shift speech data, which is original data, to text data, which is augmented data.

The neural network model may be based on a multi-modal LM capable of using text data and speech data simultaneously.

The neural network model may include a shared encoder configured to output first latent vectors based on each of preprocessed speech data and preprocessed text data, a bidirectional recurrent neural network layer configured to output second latent vectors based on each of the first latent vectors, a predictor configured to output probability vectors indicating a correlation between speech data and all FAQ pairs based on each of the second latent vectors, an FFNN layer configured to output an activation value based on a probability vector corresponding to the speech data among the probability vectors, and a classifier configured to output a final FAQ pair based on the activation value.

The deriving of the one FAQ pair may include extracting a feature vector of received speech data, obtaining preprocessed speech data by performing speech encoding on the feature vector, and inputting the preprocessed speech data to the neural network model.

The deriving of the one FAQ pair may include obtaining preprocessed text data by performing text embedding on received text data and inputting the preprocessed text data to the neural network model.

The shared encoder may have at least one of text data or speech data as an input, based on a multi-modal LM.

The bidirectional recurrent neural network layer may consider a sequential characteristic of text data or speech data.

### BRIEF DESCRIPTION OF THE DRAWINGS

FIG. 1 is a schematic block diagram illustrating an electronic device according to an embodiment;

FIG. 2 is a diagram illustrating a frequently-asked-questions (FAQ) system:

FIG. 3 is a diagram illustrating a neural network model according to an embodiment:

FIG. 4 is a diagram illustrating a training operation of a neural network model, according to an embodiment:

FIG. 5 is a diagram illustrating a neural network-based FAQ classification method according to an embodiment; and

FIG. 6 is a diagram illustrating a training method of a neural network model, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The term “unit” used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the embodiments will be described in detail with reference to the accompanying drawings. When describing the embodiments with reference to the accompanying drawings, like reference numerals refer to like elements and a repeated description related thereto will be omitted.

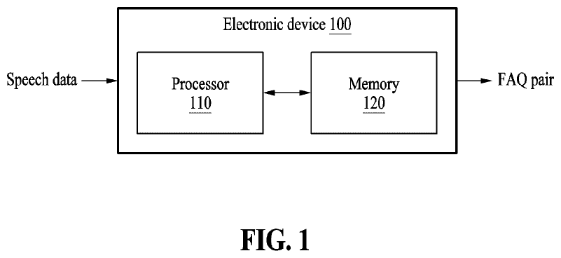

FIG. 1 is a schematic block diagram illustrating an electronic device according to an embodiment.

According to an embodiment, an electronic device 100 may derive a frequently-asked-questions (FAQ) pair based on speech data. The FAQ pair may include a question-answer pair. The FAQ pair and speech data may be, but are not limited to, associated with a vehicle (or vehicle control).

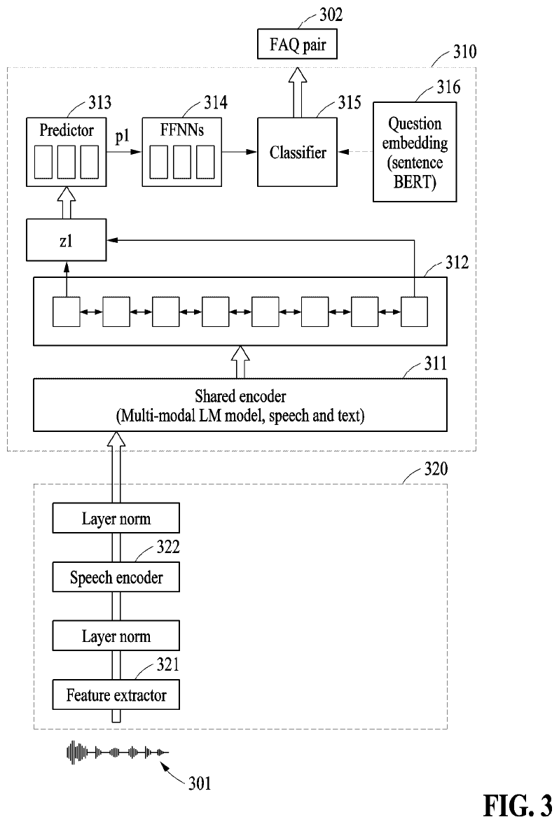

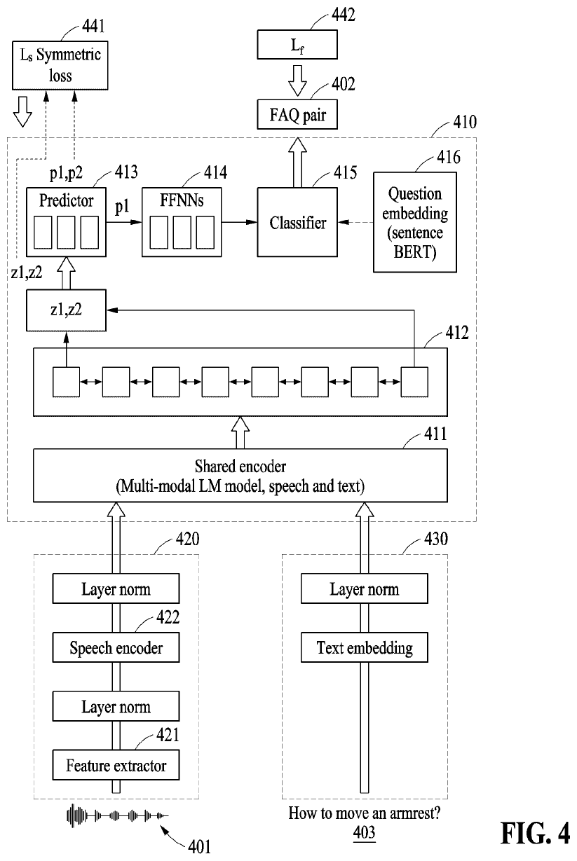

The electronic device 100 may derive the FAQ pair from speech data based on a neural network model. The operation of the neural network model is described below with reference to FIG. 3, and a training method of the neural network model is described below with reference to FIG. 4.

The neural network model may be a general model that has the ability to solve a problem, where artificial neurons (nodes) forming a network through synaptic combinations change the connection strength of synapses through training.

A neuron of a neural network may include a combination of weights or biases. The neural network may include one or more layers each including one or more neurons or nodes. The neural network may infer a desired result from a predetermined input by changing the weights of the neurons through training.

The neural network may include a deep neural network (DNN). The neural network may include a convolutional neural network (CNN), a recurrent neural network (RNN), a perceptron, a multiplayer perceptron, a feed forward (FF), a radial basis function (RBF) network, a deep feed-forward (DFF), a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN).

The electronic device 100 may use a neural network model trained in an end-to-end manner. Accordingly, the neural network model used by the electronic device 100 may be a neural network model in which modules (or layers) included in the neural network are updated at a time. The electronic device 100 may shorten the time for deriving the FAQ pair using the neural network model trained in the end-to-end manner. Since the electronic device 100 does not perform a natural language processing (NLP) operation, the electronic device 100 may not be affected by the NLP result.

The neural network model may be based on a multi modal language model (LM) capable of using text data and speech data simultaneously. The electronic device 100 may use symmetric loss for contrastive learning of the neural network model capable of using the text data and the speech data simultaneously. The symmetric loss may shift speech data, which is original data, to text data, which is augmented data. The electronic device 100 may reduce the amount of computations by performing contrast learning without a negative sample.

Multi-task learning, which uses the symmetric loss and cross-entropy loss simultaneously, may be performed on the neural network model. By enabling the information exchange in the neural network model, the overall task performance may be improved. The electronic device 100 may improve data efficiency by training the neural network model using less data than data required to train a separate model.

The electronic device 100 may be implemented within a personal computer (PC), a data server, or a portable device.

The portable device may be implemented as, for example, a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal or portable navigation device (PND), a handheld game console, an e-book, or a smart device. The smart device may be implemented as, for example, a smartwatch, a smart band, or a smart ring.

The electronic device 100 may include a processor 110 and a memory 120.

The processor 110 may process data stored in the memory 120. The processor 110 may execute computer-readable code (e.g., software) stored in the memory 120 and instructions triggered by the processor 110.

The processor 110 may be a data-processing device implemented by hardware having a circuit having a physical structure to execute desired operations. For example, the desired operations may include code or instructions in a program.

The hardware-implemented data-processing device may include, for example, a microprocessor, a CPU, a processor core, a multi-core processor, a multiprocessor, an application-specific integrated circuit (ASIC), and a field-programmable gate array (FPGA).

The memory 120 may store relational data and/or a meta graph. The memory 120 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic random-access memory (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), holographic memory, a molecular electronic memory device, and/or an insulator resistance change memory.

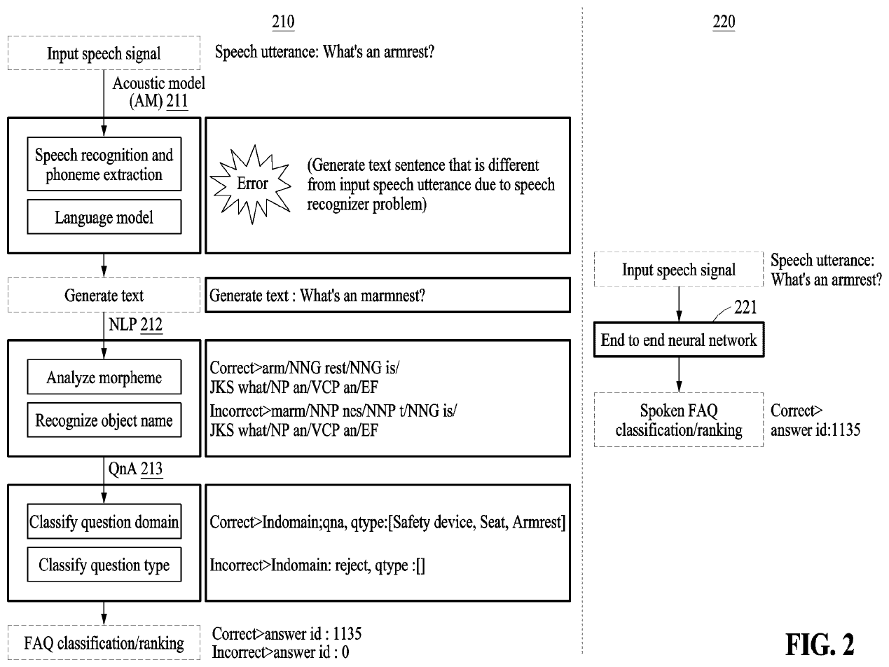

FIG. 2 is a diagram illustrating an FAQ system.

Referring to FIG. 2, the operations of FAQ systems 210 and 220 may be identified, respectively. The FAQ system 210 may include a total of three models (e.g., an acoustic model (AM) 211, an NLP model 212, and a question-and-answer (QnA) model 213). Since the FAQ system 210 includes a plurality of sequential models, errors may occur serially in subsequent models when an error occurs in one model. For example, when an initial model (e.g., the AM 211) (also referred to as an automatic speech recognition (ASR) model) that receives speech data (e.g., speech utterance) (e.g., What's an armrest?) outputs incorrect text (e.g., What's an marmnest?), the final FAQ output of the FAQ system 210 may include an error. That is, the FAQ system 210 may have high dependence on the output text of the ASR model 211.

In addition, each of the models included in the FAQ system 210 may require a maximum execution time of 300 milliseconds (ms). The FAQ system 210 may be a low-speed system that requires a processing time of about 1 second from receiving initial speech data to deriving the final FAQ pair.

According to an embodiment, the FAQ system 220 may be a system that directly derives an FAQ at the spoken level. The FAQ system 220 may use a neural network model 221 trained in an end-to-end manner. Accordingly, the neural network model 221 used by the electronic device 100 may be a neural network model in which modules (or layers) included in a neural network are updated at a time. The electronic device 100 may shorten the time for deriving the FAQ pair using the neural network model 221 trained in the end-to-end manner. Since the electronic device 100 does not perform an NLP operation, the electronic device 100 may be independent from the NLP result.

The neural network model 221 may be a pre-trained model (e.g., a bootstrap-your-own-latent (BYOL) model or a simple Siamese (SimSiam)-based pre-trained model). The neural network model 221 may differ from other pre-trained models in that the neural network model 221 uses speech data and text data together, additionally uses an RNN layer to utilize speech data and text data having sequential characteristics, uses a multi-modal LM, performs multi-task learning, and initializes an output layer using sentence embedding. Hereinafter, the neural network model 221 is described in detail.

FIG. 3 is a diagram illustrating a neural network model according to an embodiment.

Referring to FIG. 3, according to an embodiment, an electronic device (e.g., the electronic device 100 of FIG. 1) may derive an FAQ pair 302 from speech data 301 based on a neural network model 310. A preprocessing layer 320 that preprocesses the speech data 301 is described at the end of the description of FIG. 3.

The neural network model 310 may include a shared encoder 311, a bidirectional recurrent neural network layer 312, a predictor 313, an FFNN layer 314, and a classifier 315. The neural network model 310 may further include a sentence embedding layer 316.

The shared encoder 311 may output a first latent vector based on preprocessed speech data. The shared encoder 311 may be based on a multi-modal LM. The multi-modal LM may be a model capable of using text data and speech data simultaneously. The neural network model 310 may derive the FAQ pair 302 using only the speech data 301, but text data may be used together with speech data in the training of the neural network model 310. The training of the neural network model 310 is described in detail below with reference to FIG. 4.

The bidirectional recurrent neural network layer 312 may output a second latent vector z1 based on the first latent vector. The bidirectional recurrent neural network layer 312 may consider the sequential characteristics of text data or speech data.

The predictor 313 may output a probability vector p1 indicating the correlation between speech data and all FAQ pairs based on the second latent vector z1. The FFNN layer 314 may output an activation value based on the probability vector p1. The classifier 315 may output the final FAQ pair 302 based on the activation value.

The sentence embedding layer 316 may initialize an output layer by performing sentence embedding.

The electronic device 100 may preprocess the speech data 301 through the preprocessing layer 320. The electronic device 100 may extract a feature vector of the speech data 301 based on a feature extractor 321. The electronic device 100 may obtain preprocessed speech data from the feature vector based on a speech encoder 322.

The neural network model 310 may use the preprocessed speech data as input data but is not limited thereto, and the neural network model 310 may also use speech data 301 that is not preprocessed as input data. Hereinafter, a training method of the neural network model 310 is described.

FIG. 4 is a diagram illustrating a training operation of a neural network model, according to an embodiment.

Referring to FIG. 4, according to an embodiment, an electronic device (e.g., the electronic device 100 of FIG. 1) may train a neural network model 410. The training result of the neural network model 410 may be the neural network model 310 of FIG. 3.

The electronic device 100 may derive one FAQ pair 402 from speech data 401 and text data 403.

The electronic device 100 may preprocess the speech data 401 and the text data 403 through preprocessing layers 420 and 430. The preprocessing layer 430 may generate preprocessed text data by preprocessing the text data 403 (e.g., performing text embedding). The preprocessing layer 420 may generate preprocessed speech data, and since the preprocessing layer 420 is substantially the same as the preprocessing layer 320 of FIG. 3, a detailed description thereof is omitted.

The electronic device 100 may derive the one FAQ pair 402 from the preprocessed speech data and the preprocessed text data based on the neural network model 410. The one FAQ pair 402 may be the final output of the neural network model 410 based on the preprocessed speech data, and the preprocessed text data may be used for training the neural network model 410.

The neural network model 410 may be based on a multi-modal LM capable of using text data and speech data simultaneously. The neural network model 410 may use a pre-trained multi-modal (e.g., speech-text) LM as a backbone network.

The neural network model 410 may include a shared encoder 411 that outputs first latent vectors based on each of the preprocessed speech data and the preprocessed text data. The shared encoder 411 may have at least one of text data or speech data as an input, based on the multi-modal LM.

The neural network model 410 may include a bidirectional recurrent neural network layer 412 that outputs second latent vectors z1 and z2 based on each of the first latent vectors. The bidirectional recurrent neural network layer 412 may consider the sequential characteristic of text data or speech data.

The neural network model 410 may include a predictor 413 that outputs probability vectors p1 and p2 indicating the correlation between speech data and all FAQ pairs, based on each of the second latent vectors z1 and z2.

The neural network model 410 may include an FFNN layer 414 that outputs an activation value based on the probability vector p1 corresponding to speech data among the probability vectors p1 and p2. The neural network model 410 may include a classifier 415 that outputs the final FAQ pair 402 based on the activation value. The neural network model 410 may include a sentence embedding layer 416 that initializes an output layer by performing sentence embedding.

The electronic device 100 may calculate cross-entropy loss 442 based on the one FAQ pair 402 that is the final output of the neural network model 410 for speech data.

The electronic device 100 may calculate symmetric loss 441 based on the probability vectors p1 and p2 that are intermediate outputs of the neural network model 410 for each of the preprocessed speech data and the preprocessed text data. The symmetric loss 441 may be calculated based on a cosine similarity between the probability vectors p1 and p2. The symmetric loss 441 may be used for contrast learning to shift speech data, which is original data, to text data, which is augmented data. The electronic device 100 may reduce the amount of computations by performing contrast learning without a negative sample.

The electronic device 100 may perform multi-task learning, which uses the symmetric loss 441 and the cross-entropy loss 442 simultaneously, on the neural network model 410. By enabling the information exchange in the neural network model 410, overall task performance may be improved. The electronic device 100 may improve data efficiency by training the neural network model 410 using less data than data required to train a separate model.

The training of the neural network model 410 may be performed in an end-to-end manner. Accordingly, the neural network model 410 used by the electronic device 100 may be a neural network model in which modules (or layers) included in a neural network are updated at a time. The electronic device 100 may shorten the time for deriving the FAQ pair 402 using the neural network model 410 trained in the end-to-end manner.

In addition, since the electronic device 100 does not perform an NLP operation, the electronic device 100 may be independent from the NLP result.

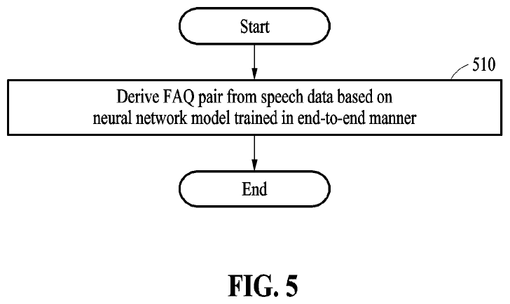

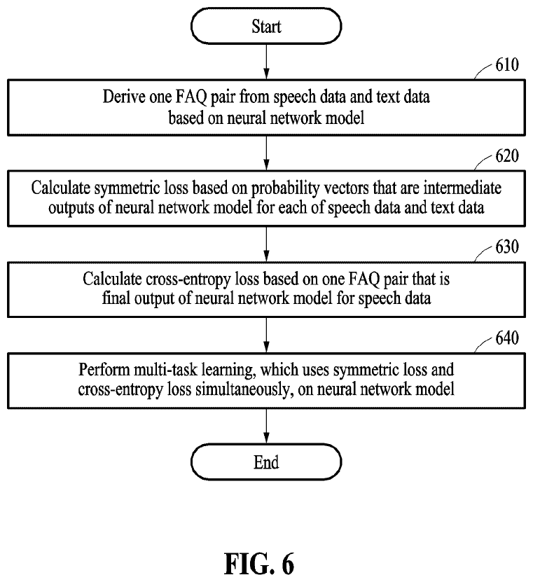

FIG. 5 is a diagram illustrating a neural network-based FAQ classification method according to an embodiment, and FIG. 6 is a diagram illustrating a training method of a neural network model, according to an embodiment.

Referring to FIGS. 5 and 6, according to an embodiment, operation 510 or operations 610 to 640 may be performed sequentially, but the present disclosure is not limited thereto. For example, two or more operations may be performed in parallel. Operation 510 or operations 610 to 640 may be substantially the same as the operation of an electronic device (e.g., the electronic device 100 of FIG. 1) described above with reference to FIGS. 1 to 4. Accordingly, a repeated description thereof is omitted.

In operation 510, the electronic device 100 may derive an FAQ pair from speech data based on a neural network model trained in an end-to-end manner. The neural network model may be based on a multi-modal LM capable of using text data and speech data simultaneously. Contrastive learning may be performed on the neural network model based on symmetric loss to shift speech data, which is original data, to text data, which is augmented data.

In operation 610, the electronic device 100 may derive one FAQ pair from speech data and text data based on a neural network model.

In operation 620, the electronic device 100 may calculate symmetric loss based on probability vectors that are intermediate outputs of the neural network model for each of speech data and text data.

In operation 630, the electronic device 100 may calculate cross-entropy loss based on the one FAQ pair that is the final output of the neural network model for speech data.

In operation 640, the electronic device 100 may perform multi-task learning, which uses the symmetric loss and the cross-entropy loss simultaneously, on the neural network model.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape: optical media such as CD-ROM discs and/or DVDs: magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Accordingly, other implementations are within the scope of the following claims.

What is claimed is:

1. An electronic device comprising:
a memory configured to store instructions; and
a processor electrically connected to the memory and configured to execute the instructions,
wherein, when the instructions are executed by the processor, the processor is configured to perform a plurality of operations,
wherein the plurality of operations comprises deriving a frequently-asked-questions (FAQ) pair from speech data based on a neural network model trained in an end-to-end manner, and
wherein the neural network model is based on a multi-modal language model (LM) capable of using text data and speech data simultaneously, and contrastive learning is performed on the neural network model based on symmetric loss to shift speech data, which is original data, to text data, which is augmented data.

2. The electronic device of claim 1, wherein multi-task learning, which uses the symmetric loss and cross-entropy loss simultaneously, is performed on the neural network model.

3. The electronic device of claim 2, wherein
the symmetric loss is calculated based on a cosine similarity between probability vectors that are intermediate outputs of the neural network model for each of speech data and text data, and
the cross-entropy loss is calculated based on the FAQ pair that is a final output of the neural network model.

4. The electronic device of claim 1, wherein the neural network model comprises:
a shared encoder configured to output a first latent vector based on preprocessed speech data;
a bidirectional recurrent neural network layer configured to output a second latent vector based on the first latent vector;
a predictor configured to output a probability vector indicating a correlation between speech data and all FAQ pairs based on the second latent vector;
a feed-forward neural network (FFNN) layer configured to output an activation value based on the probability vector; and
a classifier configured to output a final FAQ pair based on the activation value.

5. The electronic device of claim 1, wherein the deriving of the FAQ pair comprises:
extracting a feature vector of received speech data;
obtaining preprocessed speech data by performing speech encoding on the feature vector; and
inputting the preprocessed speech data to the neural network model.

6. The electronic device of claim 4, wherein the shared encoder has at least one of text data or speech data as an input, based on the multi-modal LM.

7. The electronic device of claim 4, wherein the bidirectional recurrent neural network layer considers a sequential characteristic of text data or speech data.

8. The electronic device of claim 1, wherein the neural network model has one of preprocessed speech data or non-preprocessed speech data as an input.

9. An electronic device comprising:
in a memory configured to store instructions; and
a processor electrically connected to the memory and configured to execute the instructions,
wherein, when the instructions are executed by the processor, the processor is configured to perform a plurality of operations, and
wherein the plurality of operations comprises:
deriving one frequently-asked-questions (FAQ) pair from speech data and text data based on a neural network model;
calculating symmetric loss based on probability vectors that are intermediate outputs of the neural network model for each of the speech data and the text data;
calculating cross-entropy loss based on the one FAQ pair that is a final output of the neural network model for the speech data; and
performing multi-task learning, which uses the symmetric loss and the cross-entropy loss simultaneously, on the neural network model.

10. The electronic device of claim 9, wherein the neural network model is trained in an end-to-end manner.

11. The electronic device of claim 9, wherein training of the neural network model comprises contrastive learning based on the symmetric loss to shift speech data, which is original data, to text data, which is augmented data.

12. The electronic device of claim 9, wherein the neural network model is based on a multi-modal language model (LM) capable of using text data and speech data simultaneously.

13. The electronic device of claim 9, wherein the neural network model comprises:
a shared encoder configured to output first latent vectors based on each of preprocessed speech data and preprocessed text data;
a bidirectional recurrent neural network layer configured to output second latent vectors based on each of the first latent vectors;
a predictor configured to output probability vectors indicating a correlation between speech data and all FAQ pairs based on each of the second latent vectors;
a feed-forward neural network (FFNN) layer configured to output an activation value based on a probability vector corresponding to the speech data among the probability vectors; and
a classifier configured to output a final FAQ pair based on the activation value.

14. The electronic device of claim 9, wherein the deriving of the one FAQ pair comprises:
extracting a feature vector of received speech data;
obtaining preprocessed speech data by performing speech encoding on the feature vector; and
inputting the preprocessed speech data to the neural network model.

15. The electronic device of claim 9, wherein the deriving of the one FAQ pair comprises:
obtaining preprocessed text data by performing text embedding on received text data; and
inputting the preprocessed text data to the neural network model.

16. The electronic device of claim 13, wherein the shared encoder has at least one of text data or speech data as an input, based on a multi-modal LM.

17. The electronic device of claim 13, wherein the bidirectional recurrent neural network layer considers a sequential characteristic of text data or speech data.
